(19) United States
(12) Patent Application Publication
(10) Pub. No.: US 2008/0069150 A1
(43) Pub. Date: Mar. 20, 2008

(54) Precision Time Protocol Emulation for Network Supportive of Circuit Emulation Services

(76) Inventors: Sig Harold Badt, Richardson, TX (US); Timucin Ozugur, Fairview, TX (US)

Correspondence Address: ALCATEL LUCENT;INTELLECTUAL PROPERTY & STANDARDS, 3400 W. PLANO PARKWAY, MS LEGL2, PLANO, TX, 75075, US

(21) Appl. No.: 11/551,544

(22) Filed: Oct. 20, 2006

Related U.S. Application Data
(60) Provisional application No. 60/826,166, filed on Sep. 19, 2006.

(51) Int. Cl. H04J 3/06

(52) U.S. Cl. 370/503; 370/252

(57) ABSTRACT

Precision Time Protocol (PTP) emulation service for a data communication network of a type that is adapted to support circuit emulation services (CES). The PTP emulation service enables seamless PTP-style clock synchronization over such a network using any combination of legacy switches, PTP boundary switches and PTP switches. The PTP emulation service is delivered through the expedient of external PTP emulation devices that are associated with legacy switches and PTP boundary switches.

### PRIORITY UNDER 35 U.S.C. § 119(e) & 37 C.F.R. § 1.78

This nonprovisional application claims priority based upon the following prior United States provisional patent application entitled: “IEEE 1588 Enhancement,” Application No. 60/826,166, filed on Sep. 19, 2006, in the names of: Sig Harold Badt, Jr. and Timucin Ozugur, which is hereby incorporated by reference.

### BACKGROUND OF THE INVENTION

This invention relates to clock synchronization within a data communication network adapted to support circuit emulation services and, more particularly, methods and systems for emulating IEEE Std. 1588 Precision Time Protocol clock synchronization within such a network and a subsystems for use therein.

Circuit Emulation Services (CES) make it possible to carry synchronous traffic, such as T1/E1, SDH and SONET traffic, over asynchronous networks, such as Ethernet networks. Due to the time-sensitivity of synchronous traffic, an Ethernet network supporting CES must transport a precise amount of data within a predefined time. This requirement means that Ethernet switches participating in CES must be highly synchronized.

A networking standard known as IEEE Std. 1588 Precision Time Protocol (PTP) provides precision synchronization of the clocks of networked devices, such as Ethernet switches participating in CES. The protocol achieves precision synchronization through transmission between PTP-compliant networked devices of PTP-compliant clock synchronization messages including SYNC, FOLLOW_UP, DELAY_REQ and DELAY_RESP messages, all of which use a multicast address reserved for PTP as a destination address.

Referring to FIG. 1, basic PTP operation is shown between two PTP switches 10, 20. Switch 10 includes a master PTP module 12 and a time measurement element 14 while switch 20 includes a slave PTP module 22 and a time measurement element 24. Module 12 sends its master clock time to module 22 in a SYNC packet. Module 22 receives the SYNC packet and sets its slave clock time to the master clock time in the SYNC packet.

On-switch transmission delays experienced by the SYNC packet are then accounted for using a FOLLOW_UP packet. A first on-switch delay is introduced between the time module 12 put the time in the SYNC packet and the time the SYNC packet departed switch 10. This delay is determinable from a measurement of the departure time from switch 10 of the SYNC packet taken by time measurement element 14. Module 12 sends a FOLLOW_UP packet to module 22 with an accounting of this first on-switch delay. A second on-switch delay introduced in switch 20 between receipt of the SYNC packet and reading of the SYNC packet by module 22 is accounted for by reference to a measurement of the arrival time on switch 20 of the SYNC packet taken by time measurement element 24. Module 22 receives the FOLLOW_UP packet and the measurement of arrival time of the SYNC packet and adjusts its clock to account for these on-switch delays.

At that point, only the delay experienced by the SYNC packet during propagation on the link between switch 10 and switch 20 remains unaccounted for. This delay is accounted for through the transmission of DELAY_REQ and DELAY_RESP packets. Module 22 sends a DELAY_REQ packet to module 12 and in the process time measurement element 24 measures the time of departure from switch 20. Module 12 receives the DELAY_REQ packet and in the process time measurement element 14 measures the time of arrival on switch 10. Module 12 sends a DELAY_RESP packet with this arrival time. Module 22 receives the DELAY_RESP packet and the measurement of departure time of the DELAY_REQ packet and adjusts its clock to account for the link propagation delay. The slave clock of module 22 is thereby synchronized to the master clock of module 12.

While PTP represents an important advance in clock synchronization for CES-over-Ethernet environments, Ethernet switches must include internal PTP hardware to support the protocol. Upgrading large installed bases of legacy Ethernet switches with PTP hardware is costly and in some cases not technically feasible.

### SUMMARY OF THE INVENTION

The present invention, in a basic feature, provides a PTP emulation service for a data communication network of a type that is adapted to support CES. The PTP emulation service enables seamless PTP-style clock synchronization over such a network using any combination of legacy switches, PTP boundary switches and PTP switches. The PTP emulation service is delivered through the expedient of external PTP emulation devices that are associated with legacy switches and PTP boundary switches. PTP emulation devices associated with legacy switches transact with other PTP emulation devices associated with adjacent legacy switches using PTP-like messages. PTP emulation devices associated with PTP boundary switches transact with another PTP emulation device associated with an adjacent legacy switch using PTP-like messages, on the one hand, and transact with a PTP stack on the PTP boundary switch using PTP-compliant messages, on the other.

In one aspect of the invention, a PTP emulation device comprises a first device port adapted to communicatively couple with a first switch port of a switch for transmitting and receiving PTP-like messages and a second device port adapted to communicatively couple with a second switch port of the switch for receiving time of departure and time of arrival information respecting transmitted and received PTP-like messages, respectively.

In some embodiments the PTP-like messages comprise one or more of synchronization, follow-up, delay request and delay response messages having a unicast address of a second PTP emulation device as a destination MAC address.

In some embodiments the PTP-like messages comprise messages transmitted to and received from a second PTP emulation device.

In some embodiments the PTP emulation device further comprises a third device port adapted to communicatively couple with a third switch port of the switch for receiving time of departure and time of arrival information respecting transmitted and received PTP-like messages, respectively.

In some embodiments the first device port is further adapted to communicatively couple with the first switch port for transmitting and receiving PTP-compliant messages.

In some embodiments the PTP-compliant messages comprise one or more of synchronization, follow-up, delay request and delay response messages having a multicast address reserved for PTP as a destination MAC address.

In some embodiments PTP-compliant messages comprise messages transmitted to and received from a PTP stack on the switch.

In some embodiments the second switch port is PTP-disabled.

In some embodiments the first device port is communicatively coupled with the first switch port via a multiplexing device.

In some embodiments the PTP emulation device further comprises a PTP emulation module communicatively coupled with the first device port and having a PTP emulation stack, a real-time clock and a time stamp circuit and a time measurement circuit communicatively coupled with the second device port and the PTP emulation module.

In another aspect of the invention, a method for emulating PTP in a communication network having a plurality of switches comprises the steps of associating an external PTP emulation device with each of the switches and transmitting PTP-like messages between each adjacent pair of PTP emulation devices via the switches associated with each adjacent pair of PTP emulation devices.

In some embodiments the method further comprises the steps of configuring each PTP emulation device with a unicast address of each adjacent PTP emulation device.

In some embodiments, the plurality of switches comprises a PTP boundary switch and such a method further comprises the step of transmitting PTP-compliant messages between the PTP emulation device associated with the PTP boundary switch and the PTP boundary switch.

These and other features of the present invention will be better understood by reference to the detailed description of the preferred embodiment read in conjunction with the drawings briefly described below. Of course, the scope of the invention is defined by the appended claims.

### BRIEF DESCRIPTION OF THE DRAWINGS

FIG. 1 shows a two-switch architecture for conducting PTP clock synchronization in accordance with the prior art.

FIG. 2A shows a two-switch architecture for conducting PTP-style clock synchronization using PTP emulation devices in one embodiment of the invention.

FIG. 2B shows a SYNC and FOLLOW_UP message flow in the two-switch architecture of FIG. 2A.

FIG. 2C shows a DELAY_REQ and DELAY_RESP message flow in the two-switch architecture of FIG. 2A.

FIG. 3A shows a three-switch architecture for conducting PTP-style clock synchronization using PTP emulation devices in another embodiment of the invention.

FIG. 3B shows SYNC and FOLLOW_UP message flows in the three-switch architecture of FIG. 3A.

FIG. 3C shows DELAY_REQ and DELAY_RESP message flows in the three-switch architecture of FIG. 3A.

FIG. 4A shows a three-switch architecture for conducting PTP-style clock synchronization using PTP emulation devices in yet another embodiment of the invention.

FIG. 4B shows SYNC and FOLLOW_UP message flows in the three-switch architecture of FIG. 4A.

FIG. 4C shows DELAY_REQ and DELAY_RESP message flows in the three-switch architecture of FIG. 4A.

FIG. 5 is a flow diagram illustrating a method for performing PTP-style clock synchronization in a hybrid network having a combination of legacy switches, PTP boundary switches and PTP switches in one embodiment of the invention.

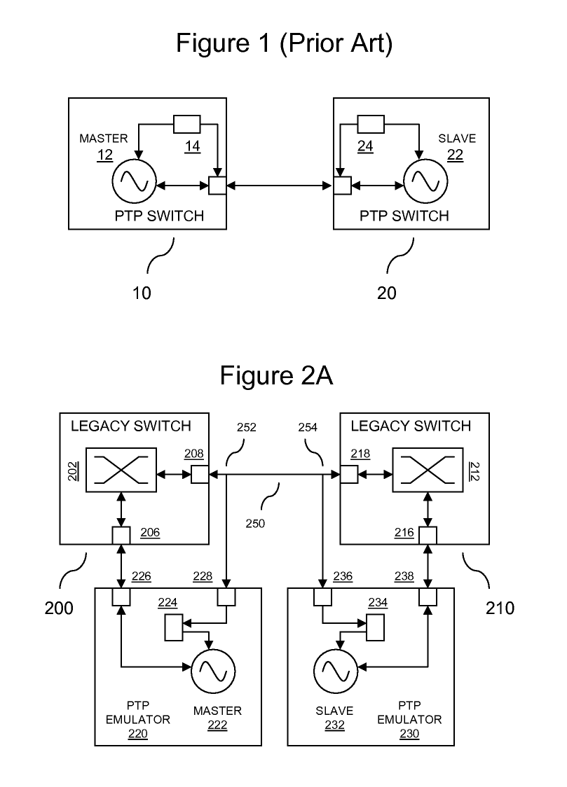

### DETAILED DESCRIPTION OF A PREFERRED EMBODIMENT

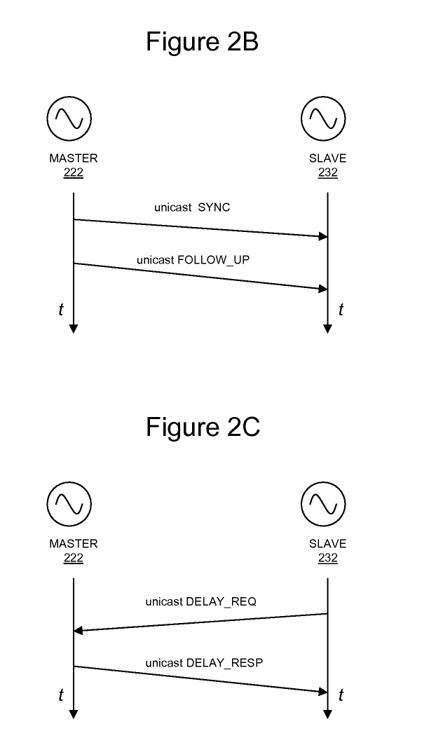

In FIG. 2A, a two-switch architecture for conducting PTP-style clock synchronization using PTP emulation devices is shown in one embodiment of the invention. In the two-switch architecture, legacy Ethernet switches 200, 210 are communicatively coupled via an Ethernet link 250. Switch 200 has switch ports 206, 208 that are communicatively coupled via switch fabric 202. Similarly, switch 210 has switch ports 216, 218 that are communicatively coupled via switch fabric 212. Switches 200, 210 do not have internal logic for supporting PTP in accordance with IEEE Std. 1588. However, PTP emulators 220, 230 associated and communicatively coupled with switches 200, 210, respectively, provide a PTP emulation service that supports PTP-style clock synchronization between switches 200, 210 via Ethernet link 250.

Emulator 220 is a PTP emulation device having a PTP emulation module 222 and a time measurement module 224. Emulation module 222 has a real-time clock, a time stamp circuit and a PTP emulation stack. Emulation module 222 generates PTP-like messages and transmits and receives PTP-like messages via device port 226. Emulation module 222 further receives time-of-departure (TOD) and time-of-arrival (TOA) information respecting such messages from time measurement module 224.

Time measurement module 224 has a time measurement circuit. Time measurement module 224 is communicatively coupled with device port 228. Time measurement module 224 listens for PTP-like messages departing from and arriving at switch port 208 and determines the TOD and TOA of such messages. Time measurement module 224 relays TOA and TOD information respecting such messages to emulation module 222.

Device port 226 is communicatively coupled with switch port 206. In some embodiments, such communicative coupling is achieved via a direct connection, such as an Ethernet link. In other embodiments, communicative coupling is achieved via an intermediate multiplexing device, such as an Ethernet switch or hub. It will be appreciated that by interposing a multiplexing device between switch port 206 and device port 226, a PTP emulation service can be implemented without dedicating any port of switch 200 to the service.

Device port 228 is communicatively coupled with a tap 252 positioned near the end of Ethernet link 250 that is attached to switch port 208. Such communicative coupling is achieved via a direct connection.

Emulator 230 is a PTP emulation device having components 232, 234, 236, 238 that are counterparts of components 222, 224, 226, 228 on emulator 220. These counterpart components work with each other and switch and link components 216, 218, 254 in a manner similar to that described above in relation to emulator 220.

In the embodiment shown, the real-time clock of emulation module 222 is designated as the master clock for purposes of PTP-style clock synchronization, whereas the real-time clock of emulation module 232 is designated as the slave clock for such purposes. PTP-style clock synchronization is realized through the exchange of PTP-like messages, including SYNC, FOLLOW_UP, DELAY_REQ and DELAY_RESP.

Turning to FIG. 2B, a SYNC and FOLLOW_UP message flow in the two-switch architecture of FIG. 2A are shown in one embodiment of the invention, wherein the direction and timing of SYNC and FOLLOW_UP messages is illustrated. SYNC and FOLLOW_UP messages are transmitted in Ethernet frames compliant with PTP in all respects except that such frames include a unicast destination MAC address rather than a multicast destination MAC address reserved for PTP. More particularly, SYNC and FOLLOW_UP frames include as a destination MAC address a unicast MAC address that has been assigned to PTP emulator 230 and configured on PTP emulator 220.

Emulation module 222 transmits a unicast SYNC message at a defined interval, such as every two seconds. The PTP emulation stack of emulation module 222 generates a SYNC message and the time stamp circuit of emulation module 222 instantiates in the message the current time from the real-time master clock of emulation module 222. The SYNC message is encapsulated in an Ethernet frame and transmitted via device port 226, switch port 206 and switch port 208 onto Ethernet link 250 and via switch port 218, switch port 216 and device port 238 to emulation module 232. Switch port 208 and switch port 216 are configured as forwarding ports on switch 200 and switch 210, respectively, for received frames having the MAC address assigned to PTP emulator 230 as a destination MAC address. Emulation module 232 sets the time of the real-time slave clock of emulation module 232 to the time in the message.

Time measurement module 224 intercepts the SYNC message during transmission by listening on tap 252 and determines the TOD from switch 200 of the SYNC message. Module 224 compensates for the delay between the time the SYNC message leaves switch 200 and the time the SYNC message is detected. Time measurement module 224 relays the TOD determination to emulation module 222.

Time measurement module 234 intercepts the SYNC message during transmission by listening on tap 254 and determines the TOA on switch 210 of the SYNC message. Module 234 compensates for the delay between the time the SYNC message arrives at switch 210 and the time the SYNC message is detected. Time measurement module 234 relays the TOA determination to emulation module 232.

Emulation module 222 next transmits a unicast FOLLOW_UP message. The PTP emulation stack of emulation module 222 generates a FOLLOW_UP message and instantiates in the message the TOD determination received from time measurement module 224 respecting the SYNC message. The FOLLOW_UP message is encapsulated in an Ethernet frame and transmitted via device port 226, switch port 206 and switch port 208 onto Ethernet link 250 and via switch port 218, switch port 216 and device port 238 to emulation module 232. Emulation module 232 receives the unicast FOLLOW_UP message and uses the TOD determination in the FOLLOW_UP message and the TOA determination from time measurement module 234 respecting the SYNC message and adjusts the time of the real-time slave clock of emulation module 232 to account for the delay experienced by the SYNC message before departure through switch port 208 and after arrival on switch 210.

Turning to FIG. 2C, a DELAY_REQ and DELAY_RESP message flow in the two-switch architecture of FIG. 2A is shown in one embodiment of the invention, wherein the direction and timing of DELAY_REQ and DELAY_RESP messages is illustrated. DELAY_REQ and DELAY_RESP messages are transmitted in Ethernet frames compliant with PTP in all respects except that such frames include a unicast destination MAC address rather than a multicast destination MAC address reserved for PTP. More particularly, DELAY_REQ frames include as a destination MAC address a unicast MAC address assigned to PTP emulator 220 and this address is configured into PTP emulator 230, while DELAY_RESP frames include a unicast MAC address assigned to PTP emulator 230 and this address is configured into PTP emulator 220.

Emulation module 232 transmits a unicast DELAY_REQ message at an irregular interval that is larger than the defined interval at which SYNC messages are transmitted. In some embodiments the interval is a random time between four and 60 seconds. The PTP emulation stack of emulation module 232 generates a DELAY_REQ message. The DELAY_REQ message is encapsulated in an Ethernet frame and transmitted via device port 238, switch port 216 and switch port 218 onto Ethernet link 250 and via switch port 208, switch port 206 and device port 226 to emulation module 222. Switch port 218 and switch port 206 are configured as forwarding ports on switch 210 and switch 200, respectively, for received frames having the MAC address assigned to PTP emulator 220 as a destination MAC address.

Time measurement module 234 intercepts the DELAY_REQ message during transmission by listening on tap 254 and determines the TOD from switch 210 of such message. Time measurement module 234 relays the TOD determination to emulation module 232.

Time measurement module 224 intercepts the DELAY_REQ message during transmission by listening on tap 252 and determines the TOA on switch 200 of such message. Time measurement module 224 relays the TOA determination to emulation module 222.

Emulation module 222 next transmits a unicast DELAY_RESP message. The PTP emulation stack of emulation module 222 generates a DELAY_RESP message and instantiates in the message the TOA received from time measurement module 224 respecting the DELAY_REQ message. The DELAY_RESP message is encapsulated in an Ethernet frame and transmitted via device port 226, switch port 206 and switch port 208 onto Ethernet link 250 and via switch port 218, switch port 216 and device port 238 to emulation module 232. Emulation module 232 receives the unicast DELAY_RESP message and uses the TOA determination in the DELAY_RESP message and the TOD determination from time measurement module 234 respecting the DELAY_REQ message to adjust the time of the real-time slave clock of emulation module 232 to account for the delay experienced during propagation of the DELAY_REQ message on Ethernet link 250, which is assumed to approximate the link propagation delay experienced by the SYNC message. This adjustment to the slave clock of emulation module 232 concludes the PTP-style clock synchronization.

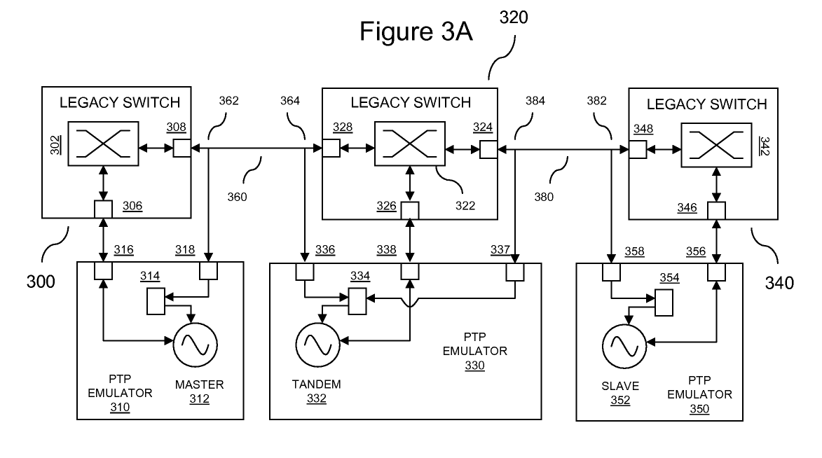

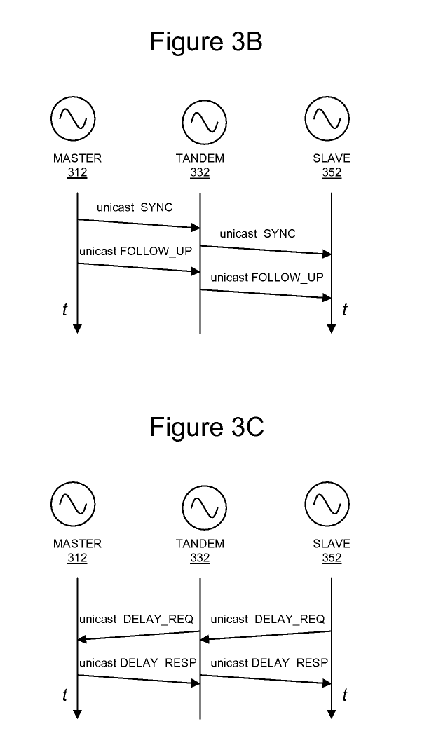

In FIG. 3A, a three-switch architecture for conducting PTP-style clock synchronization using PTP emulation devices is shown in one embodiment of the invention. In the three-switch architecture, legacy Ethernet switches 300, 320, 340 are communicatively coupled via Ethernet links 360, 380. Switch 300 has switch ports 306, 308 communicatively coupled via switch fabric 302. Switch 320 has switch ports 324, 326, 328 communicatively coupled via switch fabric 322. Switch 340 has switch ports 346, 348 communicatively coupled via switch fabric 342. Switches 300, 320, 340 do not have internal logic for supporting PTP in accordance with IEEE Std. 1588. However, PTP emulators 310, 330, 350 associated and communicatively coupled with switches 300, 320, 340, respectively, provide a PTP emulation service that supports PTP-style clock synchronization between switches 300, 320, 340 via Ethernet links 360, 380.

Emulator 310 is a PTP emulation device having a PTP emulation module 312 and a time measurement module 314. Emulation module 312 has a real-time clock, a time stamp circuit and a PTP emulation stack. Emulation module 312 generates PTP-like messages and transmits and receives PTP-like messages via device port 316. Emulation module 312 further receives TOD and TOA information respecting such messages from time measurement module 314.

Time measurement module 314 has a time measurement circuit. Time measurement module 314 is communicatively coupled with device port 318. Time measurement module 314 listens for PTP-like messages departing from and arriving at switch port 308 and determines the TOD and TOA of such messages. Time measurement module 314 relays TOA and TOD determinations to emulation module 312.

Device port 316 is communicatively coupled with switch port 306. In some embodiments, such communicative coupling is achieved via a direct connection, such as an Ethernet link. In other embodiments, communicative coupling is achieved via an intermediate multiplexing device, such as an Ethernet switch or hub.

Device port 318 is communicatively coupled with a tap 362 positioned near the end of Ethernet link 360 that is attached to switch port 308. Such communicative coupling is achieved via a direct connection.

Emulator 330 is a PTP emulation device having a PTP emulation module 332 and a time measurement module 334. Emulation module 332 has a real-time clock, a time stamp circuit and a PTP emulation stack. Emulation module 332 generates PTP-like messages and transmits and receives PTP-like messages via device port 338. Emulation module 332 further receives TOD and TOA information respecting such messages from time measurement module 334.

Time measurement module 334 has a time measurement circuit. Time measurement module 334 is communicatively coupled with device ports 336, 337. Time measurement module 334 listens for PTP-like messages departing from and arriving at switch ports 328, 324 and determines the TOD and TOA of such messages. Time measurement module 334 relays TOA and TOD determinations to emulation module 332.

Device port 338 is communicatively coupled with switch port 326. In some embodiments, such communicative coupling is achieved via a direct connection, such as an Ethernet link. In other embodiments, communicative coupling is achieved via an intermediate multiplexing device, such as an Ethernet switch or hub.

Device port 336 is communicatively coupled with a tap 364 positioned near the end of Ethernet link 360 that is attached to switch port 328. Such communicative coupling is achieved via a direct connection.

Device port 337 is communicatively coupled with a tap 384 positioned near the end of Ethernet link 380 that is attached to switch port 324. Such communicative coupling is achieved via a direct connection.

Emulator 350 is a PTP emulation device having a PTP emulation module 352 and a time measurement module 354. Emulation module 352 has a real-time clock, a time stamp circuit and a PTP emulation stack. Emulation module 352 generates PTP-like messages and transmits and receives PTP-like messages via device port 356. Emulation module 352 further receives TOD and TOA information respecting such messages from time measurement module 354.

Time measurement module 354 has a time measurement circuit. Time measurement module 354 is communicatively coupled with device port 358. Time measurement module 354 listens for PTP-like messages departing from and arriving at switch port 348 and determines the TOD and TOA of such messages. Time measurement module 354 relays TOA and TOD determinations to emulation module 332.

Device port 356 is communicatively coupled with switch port 346. In some embodiments, such communicative coupling is achieved via a direct connection, such as an Ethernet link. In other embodiments, communicative coupling is achieved via an intermediate multiplexing device, such as an Ethernet switch or hub.

Device port 358 is communicatively coupled with a tap 382 positioned near the end of Ethernet link 380 that is attached to switch port 348. Such communicative coupling is achieved via a direct connection.

In the embodiment shown, the real-time clock of emulation module 312 is designated as the master clock for purposes of PTP-style clock synchronization, whereas the real-time clock of emulation module 332 is designated as a tandem clock for such purposes, and the real-time clock of emulation module 352 is designated as a slave clock for such purposes. A tandem clock is a free-running clock that is neither a master nor a slave to any other clock. The tandem clock of emulation module 332 does not synchronize to the master clock of emulation module 312. PTP-style clock synchronization between the master clock of emulation module 312 and the slave clock of emulation module 352 is realized through the exchange of PTP-like messages, including SYNC, FOLLOW_UP, DELAY_REQ and DELAY_RESP, between emulation modules 312, 332 and 352.

Turning to FIG. 3B, SYNC and FOLLOW_UP message flows in the three-switch architecture of FIG. 3A are shown in one embodiment of the invention, wherein the direction and timing of SYNC and FOLLOW_UP messages is illustrated. SYNC and FOLLOW_UP messages are transmitted in Ethernet frames compliant with PTP in all respects except that such frames include a unicast destination MAC address rather than a multicast destination MAC address that is reserved for PTP. SYNC and FOLLOW_UP frames transmitted to PTP emulator 330 include a unicast MAC address that has been assigned to PTP emulator 330 and configured on PTP emulator 310, whereas SYNC and FOLLOW_UP frames transmitted to PTP emulator 350 include a unicast MAC address that has been assigned to PTP emulator 350 and configured on PTP emulator 330.

Emulation module 312 transmits a unicast SYNC message at a defined interval, such as every two seconds. The PTP emulation stack of emulation module 312 generates a SYNC message and the time stamp circuit of emulation module 312 instantiates in the message the current time from the real-time master clock of emulation module 312. The SYNC message is encapsulated in an Ethernet frame and transmitted via device port 316, switch port 306 and switch port 308 onto Ethernet link 360 and via switch port 328, switch port 326 and device port 338 to emulation module 332. Switch port 308 and switch port 326 are configured as forwarding ports on switch 300 and switch 320, respectively, for received frames having the MAC address assigned to PTP emulator 330 as a destination MAC address.

The PTP emulation stack of emulation module 332 replaces the MAC address assigned to PTP emulator 330 with the MAC address assigned to PTP emulator 350 as the destination MAC address and relays the SYNC message via device port 338, switch port 326 and switch port 324 onto Ethernet link 380 and via switch port 348, switch port 346 and device port 356 to emulation module 352. Emulation module 352 sets the time of the real-time slave clock of emulation module 352 to the time in the message.

Time measurement module 314 intercepts the SYNC message during transmission by listening on tap 362 and determines the TOD from switch 300 of such message. Time measurement module 314 relays the TOD determination to emulation module 312.

Time measurement module 334 intercepts the SYNC message during transmission by listening on tap 364 and determines the TOA on switch 320 of such message. Time measurement module 334 relays the TOA determination to emulation module 332.

Time measurement module 334 also intercepts the SYNC message during transmission by listening on tap 384 and determines the TOD from switch 320 of such message. Time measurement module 334 relays the TOD determination to emulation module 332.

Time measurement module 354 intercepts the SYNC message during transmission by listening on tap 382 and determines the TOA on switch 340 of such message. Time measurement module 354 relays the TOA determination to emulation module 352.

Emulation module 312 next transmits a unicast FOLLOW_UP message. In the three-switch embodiment including a tandem clock that is under consideration, the FOLLOW_UP message is modified en route to carry the aggregate propagation delays between and including switch 300 and switch 320.

Initially, the PTP emulation stack of emulation module 312 generates a FOLLOW_UP message and instantiates in the message the TOD from switch port 308 of the SYNC message received from time measurement module 314 and an aggregate propagation delay of zero. The aggregate propagation delay is thereafter revised upward to account for delays experienced by the SYNC message after departing switch port 308 in a manner hereinafter explained. The FOLLOW_UP message is encapsulated in an Ethernet frame and transmitted via device port 316, switch port 306 and switch port 308 onto Ethernet link 360 and via switch port 328, switch port 326 and device port 338 to emulation module 332.

The PTP emulation stack of emulation module 332 replaces the MAC address assigned to PTP emulator 330 with the MAC address assigned to PTP emulator 350 as the destination MAC address. The PTP emulation stack of emulation module 332 also replaces the aggregate propagation delay value of zero in the FOLLOW_UP message with a new aggregate propagation delay value that reflects the delay experienced by the SYNC message after departing switch port 308 and before departing switch port 324. In particular, through exchange of DELAY_REQ and DELAY_RESP messages between PTP emulators 310, 330 as hereinafter described with reference to FIG. 3C, emulation module 332 learns the delay experienced during propagation of the DELAY_REQ message on Ethernet link 360, which is considered to approximate the link propagation delay experienced by the SYNC message on Ethernet link 360. Moreover, through TOD and TOA measurements taken by time measurement module 334 as earlier described, emulation module 332 learns the delay experienced by the SYNC message after arriving at switch port 328 and before departing switch port 324. The new aggregate propagation delay value is the sum of the previous aggregate propagation delay value (in this case zero), the link propagation delay experienced by the DELAY_REQ message on Ethernet link 360 and the delay experienced by the SYNC message between switch ports 328 and 324. The PTP emulation stack of emulation module 332 replaces the previous aggregate propagation delay value in the FOLLOW_UP message with the new aggregate propagation delay value and relays the FOLLOW_UP message via device port 338, switch port 326 and switch port 324 onto Ethernet link 380 and via switch port 348, switch port 346 and device port 568 to emulation module 352.

Emulation module 352 receives the unicast FOLLOW_UP message and adjusts the time of the real-time slave clock of emulation module 352 by a value that reflects the entire propagation delay experienced by the SYNC message. Through exchange of DELAY_REQ and DELAY_RESP messages between emulation modules 332, 352 as illustrated in FIG. 3C, emulation module 352 learns the delay experienced during propagation of the DELAY_REQ message on Ethernet link 380, which is considered to approximate the link propagation delay experienced by the SYNC message on Ethernet link 380. From the TOA on switch port 348 of the SYNC message received from time measurement module 354, the TOD from switch port 308 of the SYNC message in the FOLLOW_UP message, the new aggregate propagation delay value in the FOLLOW_UP message and the delay experienced by the SYNC message on Ethernet link 380 estimated through exchange of DELAY_REQ and DELAY_RESP messages with emulation module 332, emulation module 352 learns the uncorrected difference between the time of its slave clock and the master clock on emulation module 312. Emulation module 352 adjusts its slave clock to account for this difference. This adjustment to the slave clock of emulation module 352 concludes the PTP-style clock synchronization.

It has been mentioned that emulation modules 332, 352 learn the delay experienced during propagation of DELAY_REQ messages on Ethernet links 360, 380 through exchange of DELAY_REQ and DELAY_RESP messages with emulation modules 312, 332. Such DELAY_REQ and DELAY_RESP flows are shown in FIG. 3C. Emulation modules 332, 352 transmit unicast DELAY_REQ messages at irregular intervals that are larger than the defined interval at which SYNC messages are transmitted, such as a random time between four and 60 seconds. A DELAY_REQ and DELAY_RESP message flow will now be described between emulation module 332 and emulation module 312, although it will be appreciated that a similar flow occurs between emulation modules 352 and 332.

The PTP emulation stack of emulation module 332 generates a DELAY_REQ message. The DELAY_REQ message is encapsulated in an Ethernet frame and transmitted via device port 338, switch port 326 and switch port 328 onto Ethernet link 360 and via switch port 308, switch port 306 and device port 316 to emulation module 312.

Time measurement module 334 intercepts the DELAY_REQ message during transmission by listening on tap 364 and determines the TOD from switch 320 of such message. Time measurement module 334 relays the TOD determination to emulation module 332.

Time measurement module 314 also intercepts the DELAY_REQ message during transmission by listening on tap 362 and determines the TOA on switch 300 of such message. Time measurement module 314 relays the TOA determination to emulation module 312.

Emulation module 312 next transmits a unicast DELAY_RESP message. The PTP emulation stack of emulation module 312 generates a DELAY_RESP message and instantiates in the message the TOA received from time measurement module 314 respecting the DELAY_REQ message. The DELAY_RESP message is encapsulated in an Ethernet frame and transmitted via device port 316, switch port 306 and switch port 308 onto Ethernet link 360 and via switch port 328, switch port 326 and device port 338 to emulation module 332. From the TOA information respecting the DELAY_REQ message instantiated in the DELAY_RESP message and the TOD information respecting the DELAY_REQ message received from time measurement module 334, emulation module 332 learns the delay experienced by the DELAY_REQ message during propagation on Ethernet link 360.

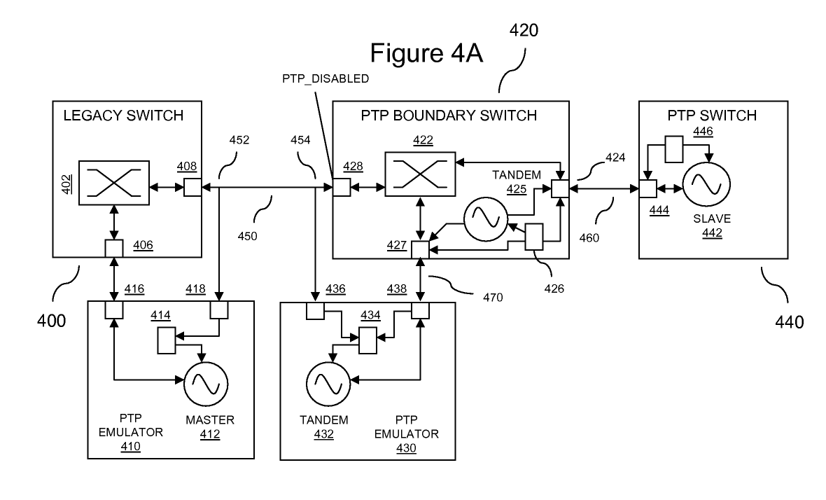

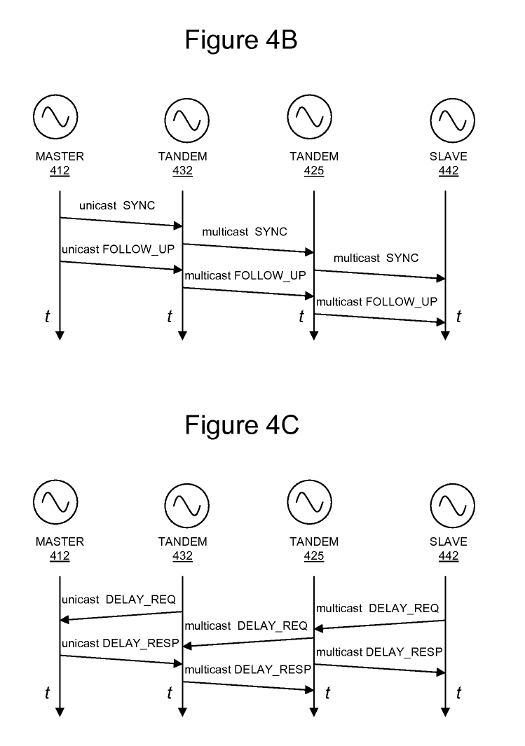

Turning now to FIG. 4A, a three-switch architecture for conducting PTP-style clock synchronization using PTP emulation devices is shown in another embodiment of the invention. In this hybrid architecture, a legacy Ethernet switch 400 and a PTP boundary switch 420 are communicatively coupled via an Ethernet link 450. PTP boundary switch 420 and a PTP switch 440 are communicatively coupled via an Ethernet link 460. Legacy switch 400 has switch ports 406, 408 communicatively coupled via switch fabric 402. PTP boundary switch 420 has switch ports 424, 427, 428 communicatively coupled via switch fabric 422. PTP switch 440 has a switch port 444. PTP boundary switch 420 and PTP switch 440 have internal logic for supporting PTP in accordance with IEEE Std. 1588, whereas legacy switch 400 does not. However, PTP emulators 410, 430 associated and communicatively coupled with switches 400, 420, respectively, enable a PTP emulation service that supports PTP-like clock synchronization between switches 400, 420 via Ethernet link 450. The PTP emulation service seamlessly extends PTP-style clock synchronization from legacy switch 400 to PTP switch 440, as will now be explained in more detail.

Emulator 410 is a PTP emulation device having a PTP emulation module 412 and a time measurement module 414. Emulation module 412 has a real-time clock, a time stamp circuit and a PTP emulation stack. Emulation module 412 generates PTP-like messages and transmits and receives PTP-like messages via device port 416. Emulation module 412 further receives TOD and TOA information respecting such messages from time measurement module 414.

Time measurement module 414 has a time measurement circuit. Time measurement module 414 is communicatively coupled with device port 418. Time measurement module 414 listens for PTP-like messages departing from and arriving at switch port 408 and determines the TOD and TOA of such messages. Time measurement module 414 relays TOA and TOD determinations to emulation module 412.

Device port 416 is communicatively coupled with switch port 406. In some embodiments, such communicative coupling is achieved via a direct connection, such as an Ethernet link. In other embodiments, communicative coupling is achieved via an intermediate multiplexing device, such as an Ethernet switch or hub.

Device port 418 is communicatively coupled with a tap 452 positioned near the end of Ethernet link 450 that is attached to switch port 408. Such communicative coupling is achieved via a direct connection.

Emulator 430 is a PTP emulation device having a PTP emulation module 432 and a time measurement module 434. Emulation module 432 has a real-time clock, a time stamp circuit and a PTP emulation stack. Emulation module 432 generates PTP-like messages destined for emulation module 412 and transmits and receives PTP-like messages via device port 438. Emulation module 412 further receives TOD and TOA information respecting PTP-like messages from time measurement module 434. Emulation module 432 also generates PTP-compliant messages destined for PTP module 425 and transmits and receives PTP-compliant messages via device port 438.

Time measurement module 434 has a time measurement circuit. Time measurement module 434 is communicatively coupled with device port 436. Time measurement module 434 listens for PTP-like messages departing from and arriving at switch port 428 and determines the TOD and TOA of such messages. Time measurement module 434 relays TOA and TOD determinations to emulation module 432.

Device port 438 is communicatively coupled with switch port 427. In some embodiments, such communicative coupling is achieved via a direct connection, such as an Ethernet link. In other embodiments, communicative coupling is achieved via an intermediate multiplexing device, such as an Ethernet switch or hub.

Device port 436 is communicatively coupled with a tap 454 positioned near the end of Ethernet link 450 that is attached to switch port 428. Such communicative coupling is achieved via a direct connection.

PTP boundary switch 420 has a PTP module 425 and a time measurement module 426 that are fully compliant with IEEE Std. 1588. PTP module 425 has a real-time clock, a time stamp circuit and a PTP stack. PTP module 425 generates PTP-compliant messages and transmits and receives PTP-compliant messages via switch ports 424, 427. PTP module 425 further receives TOD and TOA information respecting such messages from time measurement module 426.

Time measurement module 426 has a time measurement circuit. Time measurement module 426 is communicatively coupled with switch ports 424, 427. Time measurement module 426 listens for PTP-compliant messages departing from and arriving at switch ports 424, 427 and determines the TOD and TOA of such messages. Time measurement module 426 relays TOA and TOD determinations to PTP module 425.

PTP switch 440 has a PTP module 442 and a time measurement module 446 that are fully compliant with IEEE Std. 1588. PTP module 442 has a real-time clock, a time stamp circuit and a PTP stack. PTP module 442 generates PTP-compliant messages and transmits and receives PTP-compliant messages via switch port 444. PTP module 442 further receives TOD and TOA information respecting such messages from time measurement module 446.

Time measurement module 446 has a time measurement circuit. Time measurement module 446 is communicatively coupled with switch port 444. Time measurement module 446 listens for PTP-compliant messages departing from and arriving at switch port 444 and determines the TOD and TOA of such messages. Time measurement module 446 relays TOA and TOD determinations to PTP module 442.

In the embodiment shown, the real-time clock of emulation module 412 is designated as the master clock for purposes of PTP-style clock synchronization. The real-time clock of emulation module 432 and the real-time clock of PTP module 425 are designated as a tandem clocks for such purposes. The real-time clock of PTP module 442 is designated as a slave clock for such purposes. Seamless PTP-style clock synchronization between the master clock of emulation module 412 and the slave clock of PTP module 442 is realized through the exchange of PTP-like messages, including SYNC, FOLLOW_UP, DELAY_REQ and DELAY_RESP, between emulation modules 412, 432 and PTP-compliant messages, including SYNC, FOLLOW_UP, DELAY_REQ and DELAY_RESP, between emulation module 432, PTP module 425 and PTP module 442.

Turning to FIG. 4B, SYNC and FOLLOW_UP message flows in the hybrid architecture of FIG. 4A are shown in one embodiment of the invention, wherein the direction and timing of SYNC and FOLLOW_UP messages is illustrated.

SYNC and FOLLOW_UP messages are transmitted between PTP emulator 410 and PTP emulator 430 in Ethernet frames compliant with PTP in all respects except that such frames include a unicast destination MAC address rather than a multicast destination MAC address that is reserved for PTP. SYNC and FOLLOW_UP frames transmitted to PTP emulator 430 include a unicast MAC address that has been assigned to PTP emulator 430 and configured on PTP emulator 410.

SYNC and FOLLOW_UP messages are transmitted between PTP emulator 430 and PTP module 425 in Ethernet frames compliant with PTP in all respects. SYNC and FOLLOW_UP frames transmitted to PTP module 425 include a multicast MAC destination address reserved for PTP and configured on PTP emulator 430.

SYNC and FOLLOW_UP messages are transmitted between PTP module 425 and PTP module 442 in Ethernet frames compliant with PTP in all respects. SYNC and FOLLOW_UP frames transmitted to PTP module 442 include a multicast MAC destination address reserved for PTP and configured on PTP module 425.

Emulation module 412 transmits a unicast SYNC message at a defined interval, such as every two seconds. The PTP emulation stack of emulation module 412 generates a SYNC message and the time stamp circuit of emulation module 412 instantiates in the message the current time from the real-time master clock of emulation module 412. The SYNC message is encapsulated in an Ethernet frame and transmitted via device port 416, switch port 406 and switch port 408 onto Ethernet link 450 and via switch port 428, switch port 427 and device port 438 to emulation module 432. Switch port 408 and switch port 427 are configured as forwarding ports on legacy switch 400 and PTP boundary switch 420, respectively, for received frames having the MAC address assigned to PTP emulator 430 as a destination MAC address.

The PTP emulation stack of emulation module 432 replaces the MAC address assigned to PTP emulator 430 with a multicast MAC address reserved for PTP as the destination MAC address and relays the SYNC message via device port 438 and switch port 427 to PTP module 425. PTP boundary switch 420 recognizes frames having a multicast MAC address reserved for PTP as a destination MAC address and forwards such frames to PTP module 425 for processing.

PTP module 425 relays the multicast SYNC message via switch port 424 and switch port 444 to PTP module 442. It bears noting that although multicast, the SYNC message is not transmitted through switch port 428 since switch port 428 is in a PTP_DISABLED state. PTP module 442 receives the multicast SYNC message and sets the time of the real-time slave clock of PTP module 442 to the time in the message.

Time measurement module 414 intercepts the SYNC message during transmission by listening on tap 452 and determines the TOD from switch 400 of such message. Time measurement module 414 relays the determination to emulation module 412.

Time measurement module 434 intercepts the SYNC message during transmission by listening on tap 454 and determines the TOA on switch 420 of such message. Time measurement module 434 relays the TOA determination to emulation module 432.

Time measurement module 434 also intercepts the SYNC message during transmission by listening on device port 438 and determines the TOD from emulator 430 of such message. Time measurement module 434 relays the TOD determination to emulation module 432.

Time measurement module 426 intercepts the SYNC message during transmission by listening on switch port 427 and determines the TOA on switch 420 of such message. Time measurement module 426 relays the TOA determination to PTP module 425.

Time measurement module 426 also intercepts the SYNC message during transmission by listening on switch port 424 and determines the TOD from switch 420 of such message. Time measurement module 426 relays the TOD determination to PTP module 425.

Time measurement module 446 intercepts the SYNC message during transmission by listening on switch port 444 and determines the TOA on switch 440 of such message. Time measurement module 446 relays the TOA determination to PTP module 442.

Emulation module 412 next transmits a unicast FOLLOW_UP message. In the hybrid architecture under consideration, the FOLLOW_UP message is modified en route to carry the aggregate propagation delays between and including switch 400 and switch 440.

Initially, the PTP emulation stack of emulation module 412 generates a FOLLOW_UP message and instantiates in the message the TOD from switch port 408 of the SYNC message received from time measurement module 414 and an aggregate propagation delay of zero. The aggregate propagation delay is thereafter revised upward to account for delays experienced by the SYNC message after departing switch port 408 in a manner hereinafter explained. The FOLLOW_UP message is encapsulated in an Ethernet frame and transmitted via device port 416, switch port 406 and switch port 408 onto Ethernet link 450 and via switch port 428, switch port 427 and device port 438 to emulation module 432.

The PTP emulation stack of emulation module 432 replaces the MAC address assigned to PTP emulator 430 with a multicast MAC address reserved for PTP as the destination MAC address. The PTP emulation stack also replaces the aggregate propagation delay value of zero with a revised aggregate propagation delay value that reflects the delay experienced by the SYNC message after departing switch port 408 and before departing device port 438 for the last time. Through exchange of DELAY_REQ and DELAY_RESP messages between emulation modules 412, 432 as hereinafter described with reference to FIG. 4C, emulation module 432 learns the delay experienced during propagation of the DELAY_REQ message on Ethernet link 450, which is considered to approximate the link propagation delay experienced by the SYNC message on Ethernet link 450. Through measurements taken by time measurement module 434 as described above, emulation module 432 learns the delay experienced by the SYNC message after arriving at switch port 428 and before departing device port 438 en route to switch port 427. The revised aggregate propagation delay value is the sum of the previous aggregate propagation delay value (in this case zero), the link propagation delay experienced by the DELAY_REQ message on Ethernet link 450 and the delay experienced by the SYNC message between arrival at switch port 428 and last departure through device port 438. The PTP emulation stack of emulation module 432 replaces the previous aggregate propagation delay value with the revised aggregate propagation delay value and relays the FOLLOW_UP message via device port 438 and switch port 427 to PTP module 425.

PTP module 425 receives the multicast FOLLOW_UP message and replaces the revised aggregate propagation delay value with a further revised aggregate propagation delay value that additionally reflects the delay experienced by the SYNC message after departure through device port 438 en route to switch port 427 and before departing switch port 424. Through transmission of DELAY_REQ and DELAY_RESP messages between emulation module 432 and PTP module 425 as hereinafter described with reference to FIG. 4C, PTP module 425 learns the delay experienced during propagation of the DELAY_REQ message on Ethernet link 470, which is considered to approximate the link propagation delay experienced by the SYNC message on Ethernet link 470. Moreover, through measurements taken by time measurement module 426 as described above, PTP module 425 learns the delay experienced by the SYNC message after arriving at switch port 427 and before departing switch port 424. The further revised aggregate propagation delay value is the sum of the revised aggregate propagation delay value, the link propagation delay experienced by the DELAY_REQ message on Ethernet link 470 and the delay experienced by the SYNC message between switch port 427 and switch port 424. The PTP stack of PTP module 425 replaces the revised aggregate propagation delay value with the further revised aggregate propagation delay value and relays the FOLLOW_UP message via switch port 424 onto Ethernet link 460 and via switch port 444 to PTP module 442. It bears noting that although multicast, the FOLLOW_UP message is not transmitted through switch port 428 since switch port 428 is in a PTP_DISABLED state.

PTP module 442 receives the multicast FOLLOW_UP message and adjusts the time of the real-time slave clock of module 442 by a value that reflects the entire propagation delay experienced by the SYNC message. Through transmission of DELAY_REQ and DELAY_RESP messages between PTP modules 425, 442 as hereinafter described with reference to FIG. 4C, PTP module 442 learns the delay experienced during propagation of the DELAY_REQ message on Ethernet link 460, which is considered to approximate the link propagation delay experienced by the SYNC message on Ethernet link 460. From the TOA on switch port 444 of the SYNC message received from time measurement module 446, the TOD from switch port 408 of the SYNC message in the FOLLOW_UP message, the further revised aggregate propagation delay value in the FOLLOW_UP message and the delay experienced by the SYNC message on Ethernet link 460 estimated through exchange of DELAY_REQ and DELAY_RESP messages with PTP module 425, PTP module 442 learns the uncorrected difference between the time of its slave clock and the master clock on emulation module 412. PTP module 442 adjusts its slave clock to account for this difference. This adjustment to the slave clock of PTP module 442 concludes the PTP-style clock synchronization in the hybrid architecture of FIG. 4A.

It has been mentioned that emulation module 432 and PTP modules 425, 442 learn the delay experienced during propagation of DELAY_REQ messages on Ethernet links 450, 470, 460 through exchange of DELAY_REQ and DELAY_RESP messages. Such DELAY_REQ and DELAY_RESP flows are shown in FIG. 4C. Emulation module 432 transmits unicast DELAY_REQ messages and PTP modules 425, 442 transmit multicast DELAY_REQ messages at irregular intervals that are larger than the defined interval at which SYNC messages are transmitted, such as a random time between four and 60 seconds. A DELAY_REQ and DELAY_RESP message flow will now be described between emulation module 432 and emulation module 412, although it will be appreciated that a similar flow occurs between emulation modules 352 and 332. One difference between these flows, however, is that the DELAY_REQ and DELAY_RESP message flows between PTP module 425 and emulation module 432, and between PTP module 442 and PTP module 425, include a reserved PTP multicast MAC address as a destination MAC address. Another difference is that the time measurement modules 426, 446 that are associated with PTP modules 425, 442, respectively, listen on taps that are internal to switches 420, 440.

The PTP emulation stack of emulation module 432 generates a DELAY_REQ message. The DELAY_REQ message is encapsulated in an Ethernet frame and transmitted via device port 438, switch port 427 and switch port 428 onto Ethernet link 450 and via switch port 408, switch port 406 and device port 416 to emulation module 412.

Time measurement module 434 intercepts the DELAY_REQ message during transmission by listening on tap 454 and determines the TOD from switch 420 of such message. Time measurement module 434 relays the TOD determination to emulation module 432.

Time measurement module 414 also intercepts the DELAY_REQ message during transmission by listening on tap 452 and determines the TOA on switch 400 of such message. Time measurement module 414 relays the TOA determination to emulation module 412.

Emulation module 412 next transmits a unicast DELAY_RESP message. The PTP emulation stack of emulation module 412 generates a DELAY_RESP message and instantiates in the message the TOA received from time measurement module 414 respecting the DELAY_REQ message. The DELAY_RESP message is encapsulated in an Ethernet frame and transmitted via device port 416, switch port 406 and switch port 408 onto Ethernet link 450 and via switch port 428, switch port 427 and device port 438 to emulation module 432. From the TOA information respecting the DELAY_REQ message instantiated in the DELAY_RESP message and the TOD information respecting the DELAY_REQ message received from time measurement module 434, emulation module 432 learns the delay experienced during propagation of DELAY_REQ messages on Ethernet link 450.

As mentioned, transmission of PTP-compliant messages on switch port 428 of PTP boundary switch 420 is prevented by placing switch port 428 in a PTP_DISABLED state prior to running the PTP emulation service. Disabling switch port 428 for PTP prevents PTP-compliant messages from leaking into non-PTP compliant areas of the communication network. Without such disabling, PTP-compliant messages transmitted on switch port 428 might leak into another PTP boundary switch and such PTP boundary switch might incorrectly presume adjacency with PTP boundary switch 420.

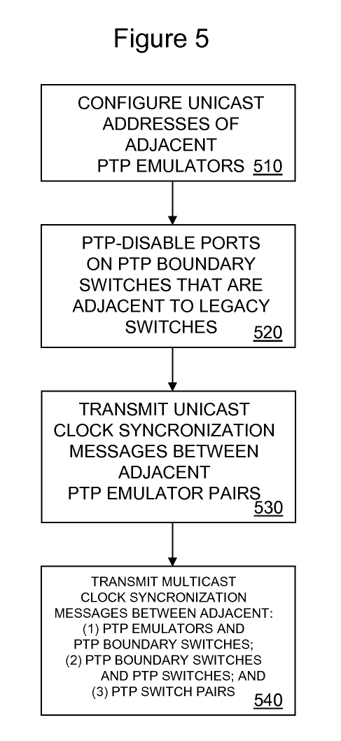

Turning to FIG. 5, a flow diagram illustrating a method for performing PTP-style clock synchronization in a hybrid network having a combination of legacy switches, PTP boundary switches and PTP switches in one embodiment of the invention is shown. Before operation of the PTP emulation service, PTP emulators and forwarding switch ports on legacy switches associated with PTP emulators are configured with unicast MAC addresses of adjacent PTP emulators (510) and switch ports on PTP boundary switches that are adjacent to legacy switches are placed in a PTP_DISABLED state (520). Operation of the PTP emulation service then commences.

Unicast clock synchronization messages are transmitted between adjacent PTP emulator pairs (530). Unicast clock synchronization messages include PTP-like SYNC messages that are transmitted at a defined interval, such as every two seconds, from PTP emulators having master clocks and tandem clocks and that have a MAC address assigned to an adjacent PTP emulator as a destination MAC address. Unicast clock synchronization messages also include PTP-like FOLLOW_UP messages that are transmitted from PTP emulators having master clocks and tandem clocks and that have a MAC address assigned to an adjacent PTP emulator as a destination MAC address. Unicast clock synchronization messages also include PTP-like DELAY_REQ messages that are transmitted at an irregular interval that is larger than the defined interval at which SYNC messages are transmitted, such as a random time between four and 60 seconds, from PTP emulators having tandem clocks and slave clocks to adjacent PTP emulators and that include a MAC address assigned to an adjacent PTP emulator as a destination MAC address. Unicast clock synchronization messages also include PTP-like DELAY_RESP messages that are transmitted from PTP emulators having tandem clocks and master clocks to adjacent PTP emulators in response to the DELAY_REQ messages. DELAY_RESP messages include a MAC address assigned to an adjacent PTP emulator as a destination MAC address.

Multicast clock synchronization messages are transmitted between other adjacent device pairs in the hybrid network that participate in PTP-style clock synchronization. These include: (1) PTP emulators that are adjacent PTP boundary switches; (2) PTP boundary switches that are adjacent PTP switches; and (3) PTP switch pairs (540). Multicast clock synchronization messages include PTP-compliant SYNC messages that are transmitted at a defined interval, such as every two seconds, from such participating devices that have master clocks and tandem clocks to such adjacent participating devices and include a multicast MAC address reserved for PTP as a destination MAC address. Multicast clock synchronization messages also include PTP-compliant FOLLOW_UP messages that are transmitted from such participating PTP devices that have master clocks and tandem clocks to such adjacent participating devices and include a multicast MAC address reserved for PTP as a destination MAC address. Multicast clock synchronization messages also include PTP-compliant DELAY_REQ messages that are transmitted at an irregular interval that is larger than the defined interval at which SYNC messages are transmitted, such as a random time between four and 60 seconds, from such participating devices having tandem clocks and slave clocks to such adjacent participating devices and include a multicast MAC address reserved for PTP as a destination MAC address. Multicast clock synchronization messages also include PTP-compliant DELAY_RESP messages that are transmitted from such participating devices that have tandem clocks and master clocks to such adjacent participating devices responsive to the DELAY_REQ messages. DELAY_RESP messages include a multicast MAC address reserved for PTP as a destination MAC address.

The legacy switches, PTP boundary switches and PTP switches in the above embodiments may be strictly Layer 2 forwarding devices that support MAC bridging in accordance with IEEE Std. 802.1D or may be Layer 2/3 forwarding devices that support both MAC bridging and network layer IP routing, for example. Moreover, such switches may perform forwarding operations using any combination of hardware and software.

Moreover, although certain components of the PTP emulators in the above embodiments are described as having circuits, the PTP emulators may generally perform their respective operations using any combination of hardware and software.

It will be appreciated by those of ordinary skill in the art that the invention can be embodied in other specific forms without departing from the spirit or essential character hereof. For example, while specific two-switch and three-switch architectures have been shown by way of example, the invention readily extends to other architectures involving various numbers and combinations of interconnected legacy switches having associated external PTP emulators, PTP boundary switches having associated external PTP emulators, and PTP switches. Moreover, while the invention has been described as using MAC-based PTP-style flows, the invention in principle could be applied to IP-based PTP-style flows. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A Precision Time Protocol (PTP) emulation device, comprising:
a first device port adapted to communicatively couple with a first switch port of a switch for transmitting and receiving PTP-like messages; and
a second device port adapted to communicatively couple with a second switch port of the switch for receiving time of departure and arrival information respecting transmitted and received PTP-like messages, respectively.

2. The device of claim 1, wherein the PTP-like messages comprise one or more of synchronization, follow-up, delay request and delay response messages having a unicast address of a second PTP emulation device as a destination MAC address.

3. The device of claim 1, wherein the PTP-like messages comprise messages transmitted to and received from a second PTP emulation device.

4. The device of claim 1, further comprising a third device port adapted to communicatively couple with a third switch port of the switch for receiving time of departure and arrival information respecting transmitted and received PTP-like messages, respectively.

5. The device of claim 1, wherein the first device port is further adapted to communicatively couple with the first switch port for transmitting and receiving PTP-compliant messages.

6. The device of claim 5, wherein the PTP-compliant messages comprise one or more of synchronization, follow-up, delay request and delay response messages having a multicast address reserved for PTP as a destination MAC address.

7. The device of claim 5, wherein the PTP-compliant messages comprise messages transmitted to and received from a PTP stack on the switch.

8. The device of claim 5, wherein the second switch port is configured in a PTP-disabled state.

9. The device of claim 1, wherein the first device port is communicatively coupled with the first switch port via a multiplexing device.

10. The device of claim 1, further comprising:
a PTP emulation module communicatively coupled with the first device port and having a PTP emulation stack, a real-time clock and a time stamp circuit; and
a time measurement module communicatively coupled with the second device port and the PTP emulation module.

11. A Precision Time Protocol (PTP) emulation device, comprising:
a first device port adapted to communicatively couple with a first switch port of a switch for transmitting and receiving unicast clock synchronization messages; and
a second device port adapted to communicatively couple with a second switch port of the switch for receiving time of departure and arrival information respecting transmitted and received unicast clock synchronization messages, respectively.

12. The device of claim 11, wherein the unicast messages comprise one or more of synchronization, follow-up, delay request and delay response messages having a unicast address of a second PTP emulation device as a destination MAC address.

13. The device of claim 11, further comprising a third device port adapted to communicatively couple with a third switch port of the switch for receiving time of departure and arrival information respecting transmitted and received unicast clock synchronization messages, respectively.

14. The device of claim 11, wherein the first device port is further adapted to communicatively couple with the first switch port for transmitting and receiving multicast clock synchronization messages.

15. The device of claim 14, wherein the multicast clock synchronization messages comprise one or more of synchronization, follow-up, delay request and delay response messages having a multicast address reserved for PTP as a destination MAC address.

16. The device of claim 11, further comprising:
a PTP emulation module communicatively coupled with the first device port having a PTP emulation stack, a real-time clock and a time stamp circuit; and
a time measurement module communicatively coupled with the second device port and the PTP emulation module.

17. A method for emulating PTP in a communication network having a plurality of switches, comprising the steps of:
associating an external PTP emulation device with each of the switches; and
transmitting PTP-like messages between each adjacent pair of PTP emulation devices via the switches associated with each adjacent pair of PTP emulation devices.

18. The method of claim 17, further comprising the step of configuring each PTP emulation device with a unicast address of each adjacent PTP emulation device.

19. The method of claim 17, wherein the plurality of switches comprises a PTP boundary switch, further comprising the step of transmitting PTP-compliant messages between the PTP emulation device associated with the PTP boundary switch and the PTP boundary switch.
